(19) United States
(12) Patent Application Publication
(10) Pub. No.: US 2018/0330619 A1
(43) Pub. Date: Nov. 15, 2018

(54) DISPLAY DEVICE AND DISPLAY METHOD FOR DISPLAYING PICTURES, AND STORAGE MEDIUM

(71) Applicant: JVC KENWOOD Corporation, Yokohama-shi (JP)

(72) Inventor: Yoshiyuki SHIMIZU, Yokohama-shi (JP)

(21) Appl. No.: 16/041,866

(22) Filed: Jul. 23, 2018

Related U.S. Application Data
(63) Continuation of application No. PCT/JP2016/086470, filed on Dec. 8, 2016.

(30) Foreign Application Priority Data
Jan. 25, 2016 (JP) 2016-011244
Oct. 20, 2016 (JP) 2016-205922

(51) Int. Cl. G08G 1/16; G06K 9/00; G06F 3/0481

(52) U.S. Cl. CPC G08G 1/166; G06F 3/04817; G06K 9/00369; G06K 9/00805

(57) ABSTRACT

A picture deriving unit derives picture information of a picture of vicinity of a vehicle captured by an imager. A person detector detects a person in picture information derived by the picture deriving unit. A movement detector detects the moving direction of a person detected by the person detector, in picture information derived by the picture deriving unit. A display controller displays, on a display unit, picture information derived by the picture deriving unit and an icon indicating the moving direction of a person detected by the movement detector.

### CROSS-REFERENCE TO RELATED APPLICATION

This application is based upon and claims the benefit of priority from the prior Japanese Patent Application No. 2016-011244, filed on Jan. 25, 2016 and Japanese Patent Application No. 2016-205922, filed on Oct. 20, 2016, the entire contents of which are incorporated herein by reference.

### BACKGROUND

### 1. Field

The present invention relates to display technology, and particularly to a display device and a display method for displaying pictures and to a storage medium.

### 2. Description of the Related Art

There has been provided the function to capture a picture using a camera mounted on a vehicle, detect a pedestrian based on picture recognition, and warn the driver of the existence of the pedestrian. For example, a motion vector of a pedestrian is calculated based on picture recognition, and the pedestrian for warning is identified based on the motion vector. Since a pedestrian is always detected at the current position of the pedestrian even when the pedestrian is moving, it can be said that the function is performed substantially following the movement of the pedestrian (see Patent Document 1, for example).

[Patent Document 1] Japanese Unexamined Patent Application Publication No. 2014-006776

The function of this kind, however, merely provides the current position of a pedestrian. Accordingly, the driver has to presume how the pedestrian will move afterward, and the driver also needs to always check the movement of a pedestrian moving in a direction related to the traveling direction of the vehicle. For example, even if a pedestrian for warning is identified, the driver has no idea which direction the pedestrian is moving in. Also, since the range visually checked by a driver is limited, when a pedestrian, whom the driver has not noticed, moves in a direction related to the traveling direction of the vehicle, the driver may first notice the pedestrian.

### SUMMARY

To solve the problems above, a display device of one aspect of the present embodiment includes; a picture deriving unit that derives picture information of a captured picture of vicinity of a vehicle; a person detector that detects a person in picture information derived by the picture deriving unit; a movement detector that detects the moving direction of a person detected by the person detector; and a display controller that displays, on a display unit, picture information derived by the picture deriving unit and an icon indicating the moving direction of a person detected by the movement detector.

Another aspect of the present embodiment relates to a display method. The display method includes: picture deriving of deriving picture information of a captured picture of vicinity of a vehicle; person detection of detecting a person in picture information derived in the picture deriving; movement detection of detecting the moving direction of a person detected in the person detection; and displaying, on a display unit, picture information derived in the picture deriving and an icon indicating the moving direction of a person detected in the movement detection.

Optional combinations of the aforementioned constituting elements, and implementations of the present embodiments in the form of methods, apparatuses, systems, recording media, and computer programs may also be practiced as additional modes of the present embodiments.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram that shows a configuration of a display device according to a first embodiment;

FIG. 2 shows a display picture generated in a picture processor shown in FIG. 1;

FIG. 3 shows another display picture generated in the picture processor shown in FIG. 1;

FIG. 4 is a diagram that shows another configuration of the display device according to the first embodiment;

FIG. 5 shows a bird's-eye picture generated in the picture processor shown in FIG. 4;

FIG. 6 shows a display picture generated in the picture processor according to a second embodiment;

FIG. 7 shows a bird's-eye picture generated in the picture processor according to the second embodiment;

FIG. 8 is a flowchart that shows a display procedure performed by the display device according to the second embodiment;

FIG. 9 shows a display picture generated in the picture processor according to a third embodiment;

FIG. 10 shows a bird's-eye picture generated in the picture processor according to the third embodiment;

FIG. 11 is a diagram that shows a configuration of the display device according to a fourth embodiment;

FIG. 12 shows a display picture generated in the picture processor shown in FIG. 11;

FIG. 13 shows another display picture generated in the picture processor shown in FIG. 11;

FIG. 14 is a diagram that shows another configuration of the display device according to the fourth embodiment;

FIG. 15 is a flowchart that shows a display procedure performed by the display device shown in FIG. 11;

FIG. 16 shows a display picture generated in the picture processor according to a fifth embodiment;

FIG. 17 shows a bird's-eye picture generated in the picture processor according to the fifth embodiment;

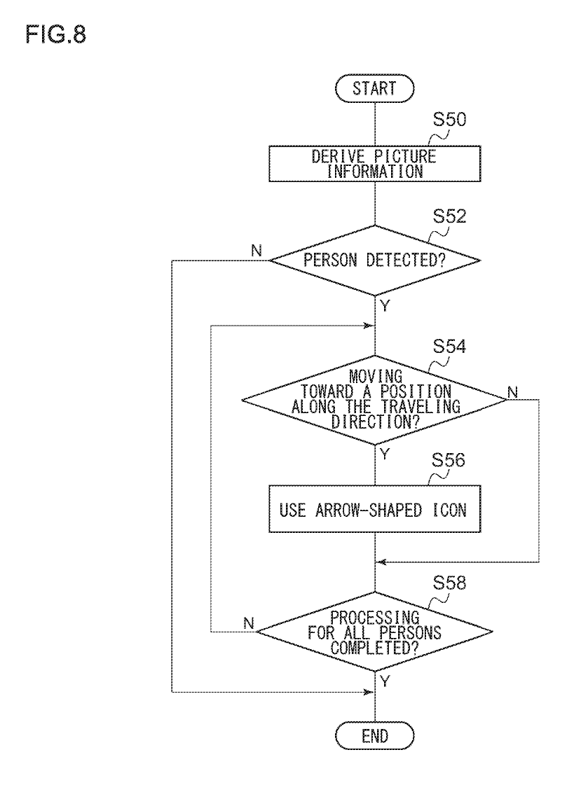

FIG. 8 is a flowchart that shows a display procedure performed by the display device according to the fifth embodiment; and

FIG. 19 is a flowchart that shows another display procedure performed by the display device according to the fifth embodiment.

### DETAILED DESCRIPTION

The invention will now be described by reference to the preferred embodiments. This does not intend to limit the scope of the present invention, but to exemplify the invention.

### First Embodiment

First, the premises are described before specific description of the present invention is given. The first embodiment relates to a display device that displays a picture captured by an imager mounted on a front part of a vehicle and that superimposes and displays, on the picture, an icon indicating the moving direction of a person. The display device according to the present embodiment detects a person in a picture and also detects the moving direction of the detected person. Further, the display device superimposes on the picture an icon corresponding to the moving direction thus detected.

In the following, embodiments of the present invention will be described with reference to the drawings. Specific numerical values are shown in the embodiments by way of example only to facilitate the understanding of the invention and should not be construed as limiting the scope of the invention unless specifically indicated as such. In the specification and drawings, elements with substantially identical functions and structures are represented by the same reference symbols so that the description thereof will not be duplicated. Also, elements not directly relevant to the invention are omitted from the illustration.

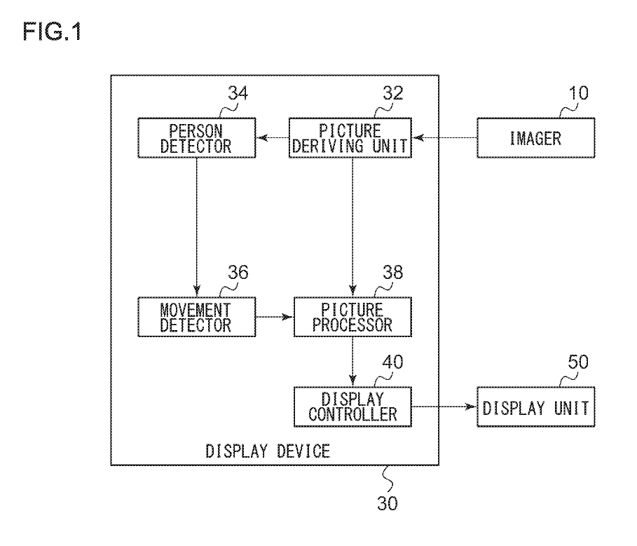

FIG. 1 shows a configuration of a display device 30 according to the first embodiment. The display device 30 is connected to an imager 10 and a display unit 50. The display device 30 comprises a picture deriving unit 32, a person detector 34, a movement detector 36, a picture processor 38, and a display controller 40. The imager 10, display device 30, and display unit 50 may be mounted on a vehicle, for example. The display device 30 may be a portable device and may be configured with the imager 10 and the display unit 50 as an integrated unit.

The imager 10 is provided at a position from which a picture of a space in front of the vehicle can be captured. For example, the imager 10 may be mounted within the vehicle cabin, on the bumper, or on the hood of the vehicle. The imager 10 captures a picture of a space in front of the vehicle moving forward, i.e., in the traveling direction. The imager 10 then outputs the captured picture of the vicinity of the vehicle (hereinafter, referred to as “picture information”) to the picture deriving unit 32. The picture information may be a digital signal, for example. The picture deriving unit 32 derives the picture information from the imager 10. The picture deriving unit 32 then outputs the picture information thus derived to the person detector 34 and the picture processor 38.

The person detector 34 receives the picture information from the picture deriving unit 32. The person detector 34 detects a picture of a person (hereinafter, such a picture is also referred to as a “person”) in the picture information. For the detection of a person, publicly-known technology can be employed. For example, the person detector 34 may store pictures of persons and information regarding characteristics of persons (hereinafter, referred to as a “person dictionary”) in advance. The person detector 34 then checks, against the person dictionary, each of multiple pictures constituting the picture information and arranged in chronological order so as to check if the picture contains a person. The person detector 34 identifies coordinates on the picture containing the detected person. When the picture contains multiple persons, the person detector 34 detects the persons. Thereafter, the person detector 34 outputs information, including the coordinates of a person detected in each picture, to the movement detector 36. At the time, the person detector 34 may also output the picture information to the movement detector 36.

The movement detector 36 receives information, including the coordinates of a person, from the person detector 34. Based on the information including the coordinates of a person, the movement detector 36 detects the moving direction of the detected person. For example, the movement detector 36 may detect the moving direction of the detected person by comparing the coordinates of the person on every picture or every unit time. More specifically, between the respective pictures or per unit time, the difference of the coordinates of the detected person and the difference of the size of the entire person or a specific portion, such as the head, of the person are derived. Based on the difference of the coordinates, movement in a circumferential direction around the subject vehicle is detected, and, based on the difference of the size, movement in a radial direction around the subject vehicle is detected; accordingly, with the both differences, the movement detector 36 detects the moving direction of a person moving in various directions.

When the person detector 34 detects multiple persons, the movement detector 36 performs the same processing for each of the multiple persons. Also, when the subject vehicle is moving during the movement detection, the movement detector 36 detects the moving direction based on a relative positional relationship with respect to the traveling speed of the subject vehicle. When the movement detector 36 has received picture information from the person detector 34, the movement detector 36 may detect the moving direction of a detected person by performing pixel difference detection and picture correlation determination. The movement detector 36 then outputs, to the picture processor 38, information regarding the moving direction of each person. The information regarding the moving direction of each person includes the coordinates of each person, for example.

The picture processor 38 receives picture information from the picture deriving unit 32 and also receives information regarding the moving direction of each person from the movement detector 36. The picture processor 38 identifies a person in each of multiple pictures included in the picture information, based on coordinates or other information included in the information regarding the moving direction of each person. Subsequently, the picture processor 38 relates the identified person to the moving direction. Further, the picture processor 38 generates a display picture 60 by superimposing on the picture an icon indicating the moving direction, such as an icon of an arrow shape pointing to the moving direction (hereinafter, referred to as an “arrow-shaped icon”) so that the arrow starts from the identified person. Namely, the picture processor 38 generates a display picture 60 that contains the picture information derived by the picture deriving unit 32 and also contains an arrow-shaped icon indicating the moving direction of a person detected by the movement detector 36.

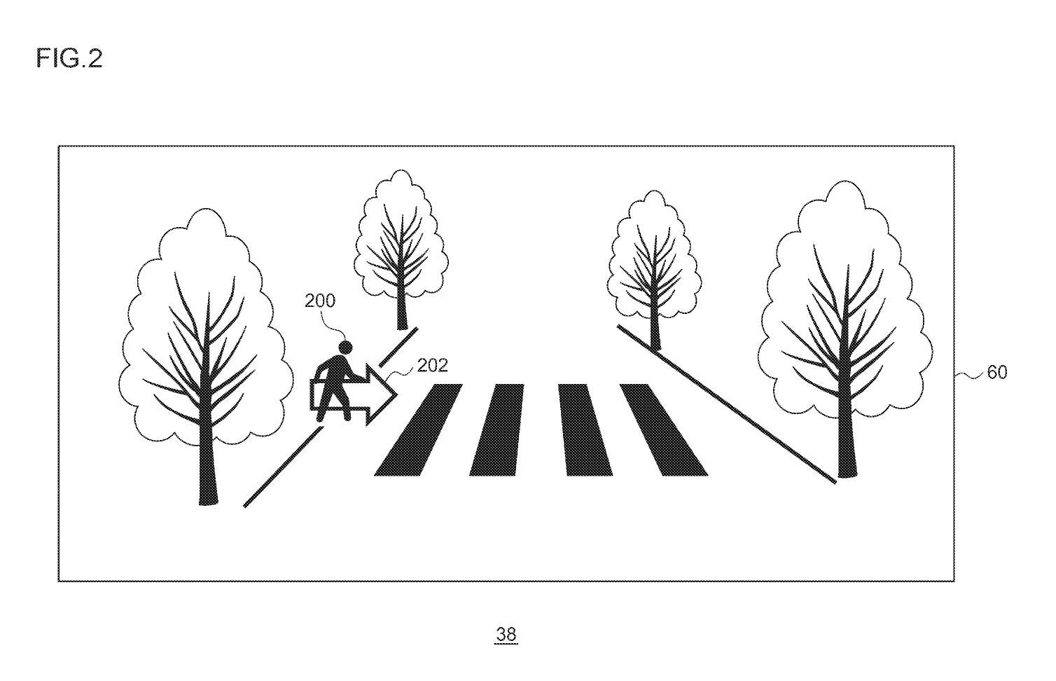

FIG. 2 shows an example of the display picture 60 generated in the picture processor 38. In FIG. 2, a person 200 is detected, and an arrow-shaped icon 202 starting from the person 200 is superimposed. The arrow-shaped icon 202 indicates that the person 200 is moving in the right direction, i.e., in the direction toward the road. The description will now return to FIG. 1. When multiple persons 200 are included, the picture processor 38 superimposes an arrow-shaped icon 202 for each person 200. The picture processor 38 performs the same processing on each picture included in the picture information so as to generate a display picture 60 corresponding to each picture. Consequently, picture information constituted by the multiple display pictures 60 is generated. For a person 200 not moving, the picture processor 38 does not superimpose an arrow-shaped icon 202. The picture processor 38 outputs the picture information constituted by the multiple display pictures 60 (hereinafter, such picture information is also referred to as “picture information”) to the display controller 40.

The display controller 40 receives the picture information from the picture processor 38. The display controller 40 then displays the picture information on the display unit 50. The display unit 50 is a display device provided at a position where the driver can visually check the display device, such as a monitor mounted on the driver's side of a vehicle. The display unit 50 displays the picture information constituted by a display picture 60 as shown in FIG. 2.

The movement detector 36 may detect, besides the moving direction, the moving speed of each person 200. For example, the movement detector 36 may detect the moving speed based on the difference of the coordinates between the respective pictures or per unit time. The moving speed is higher when the difference of the coordinates is larger, and the moving speed is lower when the difference of the coordinates is smaller. The relationships between the difference of the coordinates and the moving speed are stored in the movement detector 36 in advance. The movement detector 36 also outputs the information regarding the moving speed of each person 200 to the picture processor 38.

Accordingly, the picture processor 38 also receives the information regarding the moving speed of each person 200 from the movement detector 36. The picture processor 38 superimposes an arrow-shaped icon 202 on a person 200, as described previously, and provides adjustment so that the arrow-shaped icon 202 has an appearance corresponding to the moving speed. For example, the picture processor 38 may provide adjustment to make the arrow-shaped icon 202 longer or thicker when the moving speed is higher. Also, the picture processor 38 may determine the length of the arrow-shaped icon 202 so that the tip of the arrow is located at a position where the person 200 will reach in one second, for example. Further, the picture processor 38 may change the color of the arrow-shaped icon 202 or of the vicinity of the arrow-shaped icon 202, depending on the moving speed. For example, the picture processor 38 may make the arrow-shaped icon 202 flash when the moving speed is higher than a predetermined threshold, and may shorten the flashing period thereof as the moving speed becomes higher.

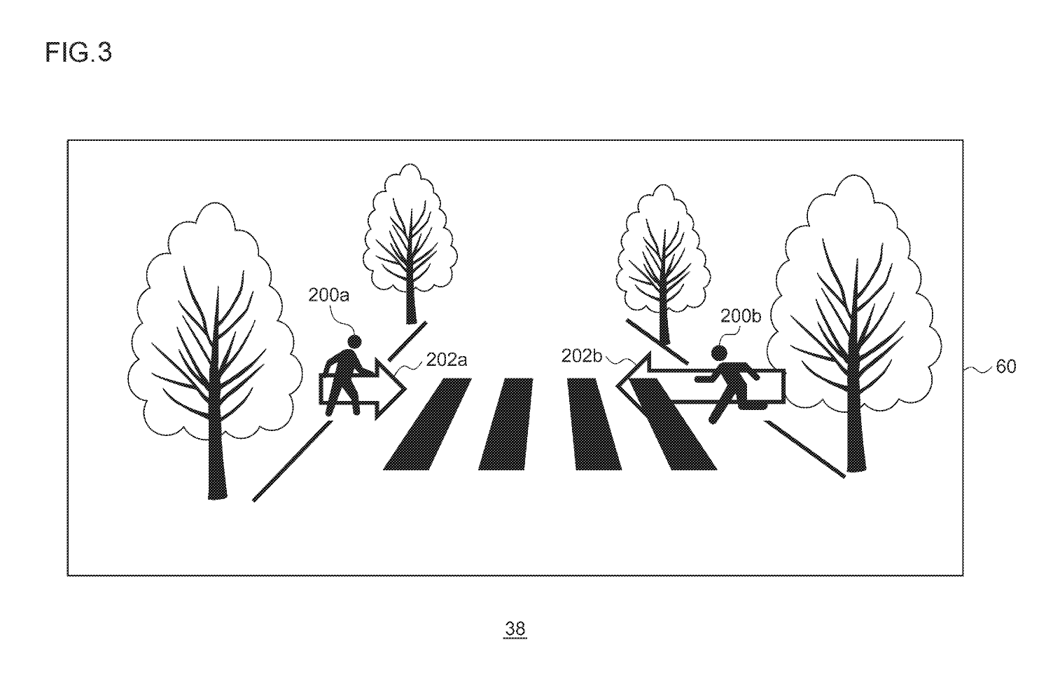

FIG. 3 shows another example of the display picture 60 generated in the picture processor 38. As shown in FIG. 3, a first arrow-shaped icon 202a is superimposed on a first person 200a, and a second arrow-shaped icon 202b is superimposed on a second person 200b. The moving speed of the second person 200b is higher than that of the first arrow-shaped icon 202a, so that the second arrow-shaped icon 202b is made longer than the first arrow-shaped icon 202a. The subsequent processing performed by the display controller 40 and the display unit 50 is the same as that described previously. Consequently, the display unit 50 displays the arrow-shaped icons 202 having appearances corresponding to the respective moving speeds.

The configuration described above may be implemented by a CPU or memory of any given computer, an LSI, or the like in terms of hardware, and by a memory-loaded program or the like in terms of software. In the present embodiment is shown a functional block configuration realized by cooperation thereof. Therefore, it would be understood by those skilled in the art that these functional blocks may be implemented in a variety of forms by hardware only, software only, or a combination thereof.

In the description above, an arrow-shaped icon 202 is superimposed on the picture information of a picture captured by the imager 10 mounted on a front part of a vehicle; however, the arrow-shaped icon 202 may be superimposed on a bird's-eye picture. A bird's-eye picture is generated by performing viewpoint conversion on pictures captured by multiple imagers mounted on a vehicle. Accordingly, although the display in the aforementioned case is provided for the situation where the vehicle moves forward, the display in this case is provided for the situation where the vehicle moves backward to be parked.

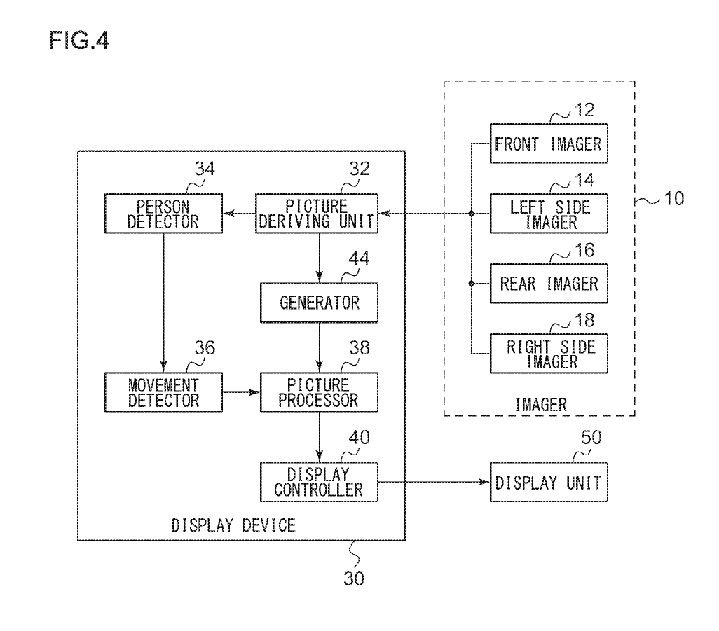

FIG. 4 shows another configuration of the display device 30 according to the first embodiment. The display device 30 is connected to the imager 10 and the display unit 50, and the imager 10 includes a front imager 12, a left side imager 14, a rear imager 16, and a right side imager 18. The display device 30 comprises the picture deriving unit 32, person detector 34, movement detector 36, picture processor 38, display controller 40, and a generator 44.

The front imager 12 corresponds to the imager 10 in the aforementioned case and is mounted on a front part of a vehicle, such as on the bumper or the hood of the vehicle. The front imager 12 defines a front imaging region in front of the vehicle and captures a picture in the front imaging region. On a left-side part of the vehicle, such as on a lower part of the left door mirror, the left side imager 14 is mounted. The left side imager 14 defines a left-side imaging region to the left of the vehicle and captures a picture in the left-side imaging region.

On a rear part of the vehicle, such as on the bumper or the trunk, the rear imager 16 is mounted. The rear imager 16 defines a rear imaging region in the rear of the vehicle and captures a picture in the rear imaging region. The right side imager 18 is mounted on a right-side part of the vehicle so that the right side imager 18 and the left side imager 14 are symmetrical. The right side imager 18 defines a right-side imaging region to the right of the vehicle and captures a picture in the right-side imaging region. The front imager 12, left side imager 14, rear imager 16, and right side imager 18 constitute the imager 10, and the imager 10 captures pictures of the vicinity of the vehicle. The front imager 12, left side imager 14, rear imager 16, and right side imager 18 output the picture information to the picture deriving unit 32.

The picture deriving unit 32 receives the picture information from each of the front imager 12, left side imager 14, rear imager 16, and right side imager 18 and outputs the picture information to the person detector 34 and the generator 44. Accordingly, the generator 44 receives the picture information from the picture deriving unit 32. The generator 44 then generates a bird's-eye picture by converting the viewpoint for each of multiple pictures included in the picture information so that the vehicle is viewed from the above. For the conversion, publicly-known technique may be used; for example, each pixel of a picture is projected on a stereoscopic curved surface in a virtual three-dimensional space, and, based on a virtual viewpoint above the vehicle, a necessary region of the stereoscopic curved surface is clipped. The clipped region corresponds to a picture after viewpoint conversion. The generator 44 outputs the bird's-eye picture to the picture processor 38.

The person detector 34 and the movement detector 36 perform the same processing as described previously to detect the coordinates and the moving direction of each person. Such detection is performed on multiple pictures included in the picture information, rather than on the bird's-eye picture. Accordingly, detected coordinates may not be included in the bird's-eye picture. The picture processor 38 receives the bird's-eye picture from the generator 44 and also receives information regarding the moving direction of each person from the movement detector 36. The picture processor 38 generates a bird's-eye picture 78 by superimposing on the bird's-eye picture an arrow-shaped icon starting from a person. Namely, the picture processor 38 generates a bird's-eye picture 78 that contains the bird's-eye picture generated in the generator 44 and also contains an arrow-shaped icon indicating the moving direction of a person detected by the movement detector 36.

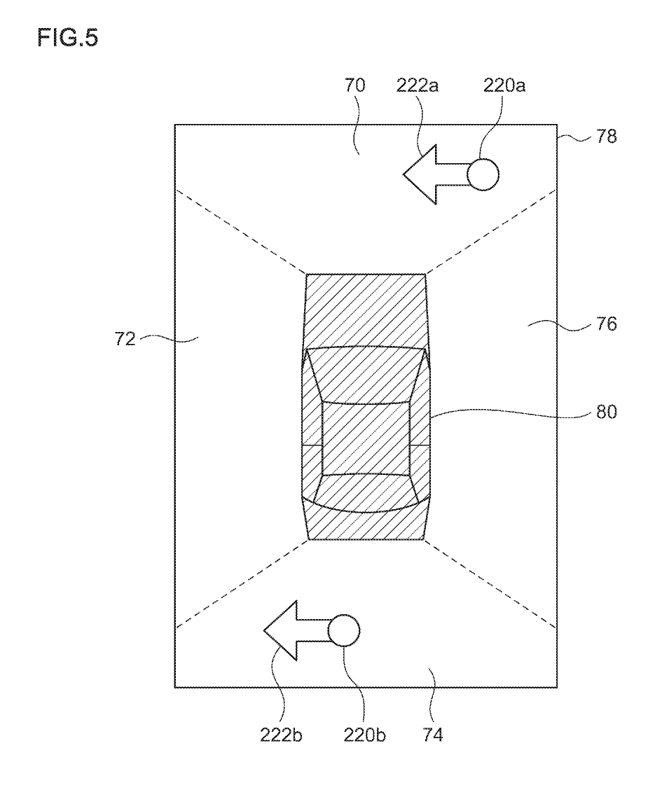

FIG. 5 shows a bird's-eye picture 78 generated in the picture processor 38. In the center part of the bird's-eye picture 78 in FIG. 5, a subject vehicle icon 80 is arranged. The subject vehicle icon 80 is a picture of a vehicle 100 viewed from the above. In front of the subject vehicle icon 80 is arranged a front picture 70, on the left side of the subject vehicle icon 80 is arranged a left side picture 72, in the rear of the subject vehicle icon 80 is arranged a rear picture 74, and on the right side of the subject vehicle icon 80 is arranged a right side picture 76. Also, on the bird's-eye picture 78, a first person icon 220a and a first arrow-shaped icon 222a starting therefrom are displayed. These icons correspond to a person 200 and an arrow-shaped icon 202 in the aforementioned case. Further, on the bird's-eye picture 78, a second person icon 220b and a second arrow-shaped icon 222b starting therefrom are also displayed. The description will now return to FIG. 4. The subsequent processing performed by the picture processor 38, display controller 40, and display unit 50 is the same as that described previously. Since the bird's-eye picture 78 is obtained through viewpoint conversion, even if a person is included in the bird's-eye picture 78, the driver may be unable to clearly recognize the person. Accordingly, a person icon 220 is displayed at the position of a person detected by the person detector 34. The person icon 220 is displayed at the lower end position of the detected person, i.e., the position closest to the center part of the bird's-eye picture 78 of the detected person.

According to the present embodiment, since an arrow-shaped icon is superimposed on a person in a display picture, the driver can find the moving direction of the person. Also, since the moving direction is detected based on a change of the coordinates of the person detected in the picture information, the moving direction can be detected only using the picture information. Since an arrow-shaped icon indicating the previous moving direction is used, the driver can presume the moving direction thereafter. Since an arrow-shaped icon having an appearance corresponding to a moving speed is displayed, the driver can find the moving speed. Also, since the length of the arrow-shaped icon is adjusted based on the moving speed, the driver can easily find the moving speed. Also, since the thickness of the arrow-shaped icon is adjusted based on the moving speed, the driver can easily find the moving speed. Further, since the color of the arrow-shaped icon is adjusted based on the moving speed, the driver can easily find the moving speed.

Since an arrow-shaped icon is superimposed on a bird's-eye picture, the driver can find the moving direction of a person when parking the vehicle, for example. Since the driver can find the moving direction of a person when parking the vehicle, the driver can safely park the vehicle. Also, since an arrow-shaped icon for a person present outside the bird's-eye picture is superimposed and displayed on the bird's-eye picture, even if the range of the bird's-eye picture is small, the driver can find the moving direction of a person to watch.

### Second Embodiment

Next, the second embodiment will be described.

As with the first embodiment, the second embodiment relates to a display device that displays a picture captured by an imager mounted on a front part of a vehicle and that superimposes and displays, on the picture, an icon indicating the moving direction of a person. When the number of persons displayed on a picture increases, the number of icons, such as arrow-shaped icons, displayed on the picture also increases. However, if many arrow-shaped icons are displayed, the arrow-shaped icons will be hard to detect for the driver, so that the alerting effect of the arrow-shaped icons will be reduced. Accordingly, the second embodiment relates to displaying for maintaining the alerting effect of the arrow-shaped icons even when the number of persons displayed on a picture increases. The display device 30 according to the second embodiment is of a similar type to the display device 30 shown in FIG. 1. Accordingly, description will be given mainly of the differences from the first embodiment.

The picture deriving unit 32, person detector 34, and movement detector 36 perform the same processing as described in the first embodiment. Also, the picture processor 38 generates a display picture 60 by superimposing on a picture an arrow-shaped icon 202 starting from an identified person 200, in the same way as described in the first embodiment. At the time, the picture processor 38 identifies the traveling direction of the subject vehicle. For example, the picture processor 38 may identify the traveling direction from the bottom toward the top in the center part in a lateral direction of the picture. The picture processor 38 superimposes an arrow-shaped icon 202 only on a person 200 moving toward a position along the traveling direction. Namely, the picture processor 38 does not superimpose an arrow-shaped icon 202 on a person 200 of which the moving direction is not toward a position along the traveling direction.

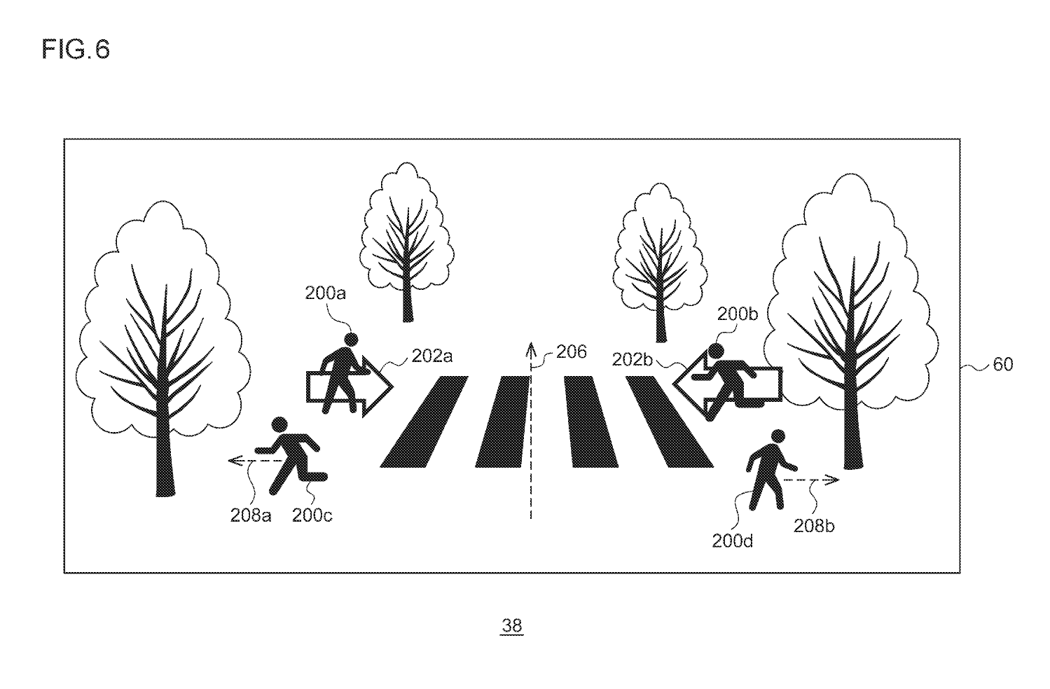

FIG. 6 shows a display picture 60 generated in the picture processor 38 according to the second embodiment. As shown in FIG. 6, a traveling direction 206 of the vehicle is indicated by a dotted line. The traveling direction 206 is shown on the display picture 60 to facilitate the explanation but is not actually displayed. On the display picture 60 are detected the first person 200a and the second person 200b, each moving toward a position along the traveling direction 206. Accordingly, the first arrow-shaped icon 202a, pointing toward a position along the traveling direction 206, is superimposed on the first person 200a, and the second arrow-shaped icon 202b, also pointing toward a position along the traveling direction 206, is superimposed on the second person 200b.

On the display picture 60, a third person 200c and a fourth person 200d are also detected. However, the third person 200c faces toward a first moving direction 208a and is not moving toward a position along the traveling direction 206. Also, the fourth person 200d faces toward a second moving direction 208b and is not moving toward a position along the traveling direction 206, either. Accordingly, arrow-shaped icons 202 are not superimposed on the third person 200c and the fourth person 200d. The description will now return to FIG. 1. The subsequent processing performed by the picture processor 38, display controller 40, and display unit 50 is the same as that described previously. Consequently, the display unit 50 only displays the arrow-shaped icons 202 each indicating a moving direction toward a position along the traveling direction of the vehicle equipped with the display device 30. This processing may be performed only when the number of arrow-shaped icons 202 displayed on a picture is a threshold or greater.

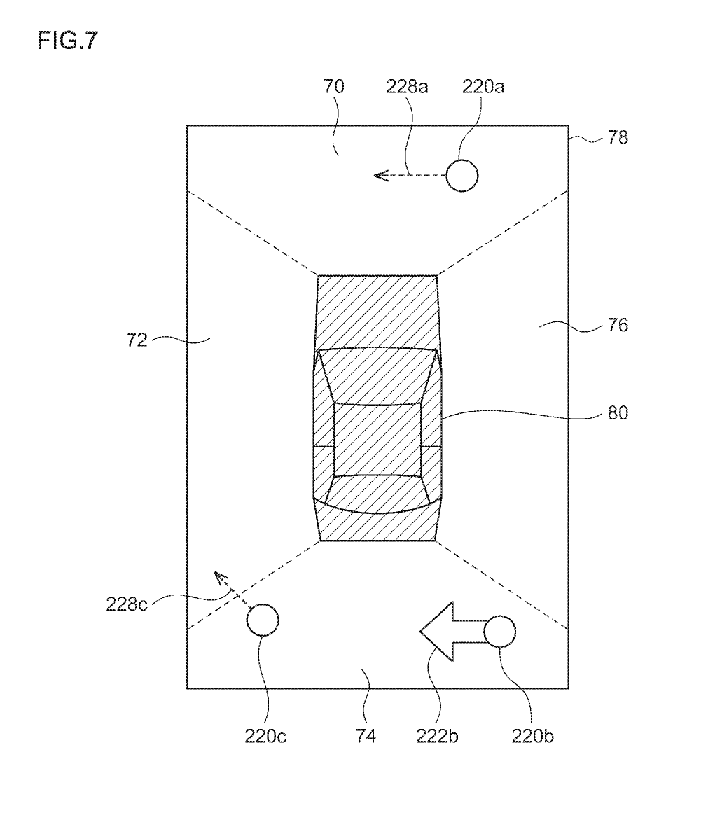

Also, this processing may be performed on a bird's-eye picture. The display device 30 in the case is of a similar type to the display device 30 shown in FIG. 4. Since the processing performed in the display device 30 is the same as that described previously, the explanation thereof is omitted here. FIG. 7 shows a bird's-eye picture 78 generated in the picture processor 38 according to the second embodiment. Since it is assumed here the case where the vehicle moves backward, the subject vehicle icon 80 in FIG. 7 moves downward. The second person icon 220b is moving toward a position along the traveling direction of the vehicle. Accordingly, on the second person icon 220b is superimposed the second arrow-shaped icon 222b pointing toward the position along the traveling direction. Meanwhile, the first person icon 220a faces toward the first moving direction 228a and is not moving toward a position along the traveling direction of the vehicle. Also, a third person icon 220c faces toward a third moving direction 228c and is not moving toward a position along the traveling direction of the vehicle, either. Therefore, arrow-shaped icons 222 are not superimposed on the first person icon 220a and the third person icon 220c.

There will now be described an operation performed by the display device 30 having the configuration set forth above. FIG. 8 is a flowchart that shows a display procedure performed by the display device 30 according to the second embodiment. The picture deriving unit 32 derives picture information (S50). If the person detector 34 does not detect a person 200 (N at S52), the process will terminate. If the person detector 34 detects a person 200 (Y at S52) and if the moving direction detected by the movement detector 36 is toward a position along the traveling direction (Y at S54), the picture processor 38 will use an arrow-shaped icon 202 (S56). On the other hand, if the moving direction detected by the movement detector 36 is not toward a position along the traveling direction (N at S54), the process of Step 56 will be skipped. If the processing for all the persons 200 is not completed (N at S58), the process will return to Step 54. If the processing for all the persons 200 is completed (Y at S58), the process will terminate.

According to the present embodiment, since only an arrow-shaped icon indicating a moving direction toward a position along the traveling direction of the vehicle is displayed, increase of arrow-shaped icons displayed on a picture can be restrained. Since increase of arrow-shaped icons displayed on a picture is restrained, the visibility of the driver can be ensured. Also, since increase of arrow-shaped icons displayed on a picture is restrained, reduction of the alerting effect for the driver can be restrained. Since an arrow-shaped icon indicating a moving direction toward a position along the traveling direction of the vehicle is displayed, even though increase of arrow-shaped icons displayed on a picture is restrained, the driver can find a person to watch.

### Third Embodiment

Next, the third embodiment will be described. As with the aforementioned embodiments, the third embodiment relates to a display device that displays a picture captured by an imager mounted on a front part of a vehicle and that superimposes and displays, on the picture, an icon indicating the moving direction of a person. If the size of a picture displayed on a display device is smaller than the size of a picture captured by an imager, a person in the picture captured by the imager may not be included in the picture displayed on the display device. However, such a person may move in a direction toward the vehicle. Accordingly, the third embodiment relates to displaying for notifying, when a person not displayed on a picture is moving in a direction toward the vehicle, the driver of the moving. The display device 30 according to the third embodiment is of a similar type to the display device 30 shown in FIG. 1. Accordingly, description will be given mainly of the differences from the aforementioned embodiments.

The person detector 34 and movement detector 36 perform the same processing as described in the aforementioned embodiments. The picture processor 38 receives picture information from the picture deriving unit 32 and also receives information regarding the moving direction of each person from the movement detector 36. Subsequently, the picture processor 38 identifies a person in a picture and relates the identified person to the moving direction. The picture processor 38 also generates a display picture 60 by superimposing on the picture an arrow-shaped icon starting from the identified person.

At the time, the picture processor 38 generates the display picture 60 by clipping part of the picture information derived by the picture deriving unit 32. Namely, the size of the display picture 60 is smaller than the size of the picture information derived by the picture deriving unit 32. Accordingly, the identified person may not be included in the display picture 60. Even in such a case, when the display picture 60 contains an arrow-shaped icon indicating the moving direction of a person present outside the range of the display picture 60, the picture processor 38 includes the arrow-shaped icon in the display picture 60. This corresponds to including, in a display picture 60, an arrow-shaped icon indicating the moving direction of a person who is present outside the range of the display picture 60 and is moving toward the range of the display picture 60.

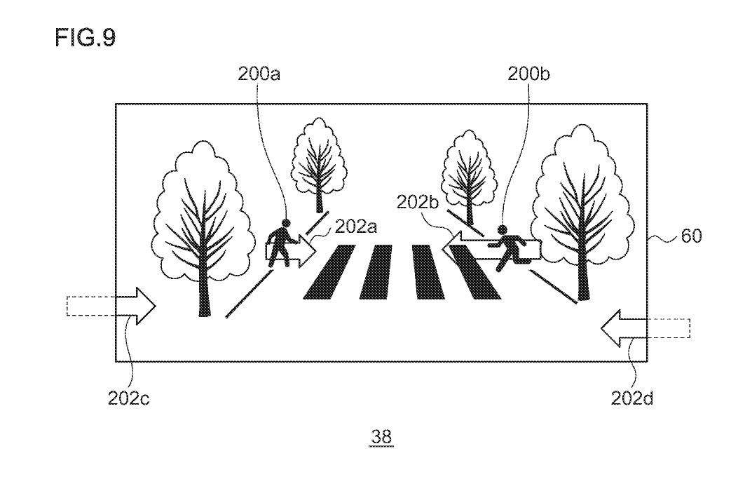

FIG. 9 shows a display picture 60 generated in the picture processor 38 according to the third embodiment. The first person 200a, second person 200b, first arrow-shaped icon 202a, and second arrow-shaped icon 202b are displayed similarly to those in FIG. 3. Meanwhile, since the third person 200c and the fourth person 200d are present outside the display picture 60, they are not displayed on the display picture 60. However, a third arrow-shaped icon 202c starting from the third person 200c and a fourth arrow-shaped icon 202d starting from the fourth person 200d are included within the display picture 60. In other words, the third arrow-shaped icon 202c and the fourth arrow-shaped icon 202d point toward the inside of the display picture 60. Accordingly, on the display picture 60, the third person 200c and the fourth person 200d are not displayed, but the third arrow-shaped icon 202c and the fourth arrow-shaped icon 202d indicating the moving directions of the third person 200c and the fourth person 200d are displayed.

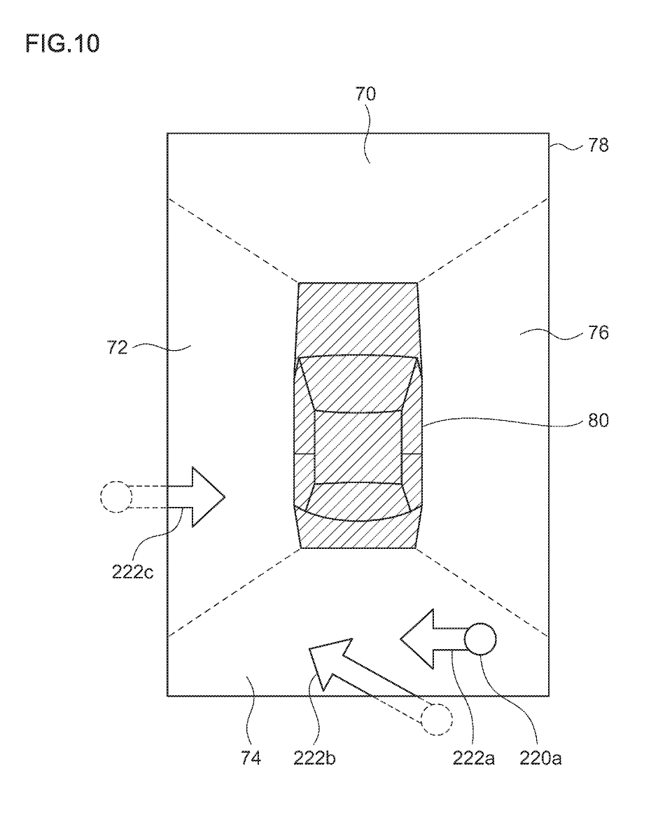

Such processing may be performed on a bird's-eye picture. The display device 30 in the case is of a similar type to the display device 30 shown in FIG. 4. Since the processing performed in the display device 30 is the same as that described previously, the explanation thereof is omitted here. FIG. 10 shows a bird's-eye picture 78 generated in the picture processor 38 according to the third embodiment. Since the first person icon 220a is present within the bird's-eye picture 78, the first person icon 220a is displayed on the bird's-eye picture 78, and the first arrow-shaped icon 222a starting from the first person icon 220a is also displayed on the bird's-eye picture 78.

Meanwhile, since the second person icon 220b and the third person icon 220c are present outside the bird's-eye picture 78, they are not displayed on the bird's-eye picture 78. However, the second arrow-shaped icon 222b starting from the second person icon 220b is included within the bird's-eye picture 78. Accordingly, on the bird's-eye picture 78, the second person icon 220b is not displayed, but the second arrow-shaped icon 222b indicating the moving direction of the second person icon 220b is displayed. Similarly to the second arrow-shaped icon 222b, a third arrow-shaped icon 222c is also displayed. Consequently, the display unit 50 displays the bird's-eye picture 78 on which are superimposed arrow-shaped icons 222 each indicating the moving direction of a corresponding person icon 220 present outside the bird's-eye picture 78.

According to the present embodiment, even when a person is not included in a display picture, an arrow-shaped icon starting from the person is included in the display picture, so that the driver can find the moving direction of the person. Also, even when a person icon is not included in a bird's-eye picture, an arrow-shaped icon starting from the person icon is included in the bird's-eye picture, so that the driver can find the moving direction of the person corresponding to the person icon.

### Fourth Embodiment

Next, the fourth embodiment will be described. As with the aforementioned embodiments, the fourth embodiment relates to a display device that displays a picture captured by an imager mounted on a front part of a vehicle and that superimposes and displays, on the picture, an icon indicating the moving direction of a person. When the number of persons displayed on a picture increases, the number of icons, such as arrow-shaped icons, displayed on the picture also increases. However, as the traveling speed of the vehicle gets higher, the number of arrow-shaped icons that can be recognized by the driver is reduced. Accordingly, the fourth embodiment relates to adjustment of the number of arrow-shaped icons based on the traveling speed of the vehicle. In the present embodiment, description will be given mainly of the differences from the aforementioned embodiments. When many persons are displayed on a picture, an upper limit may be provided in the number of arrow-shaped icons. For example, for a group of persons moving in nearly the same direction at nearly the same speed, one collective arrow-shaped icon may be displayed, or arrow icons fewer than the persons may be displayed. In this case, the arrow icons may be displayed so that they can be recognized as collective arrow icons for multiple persons.

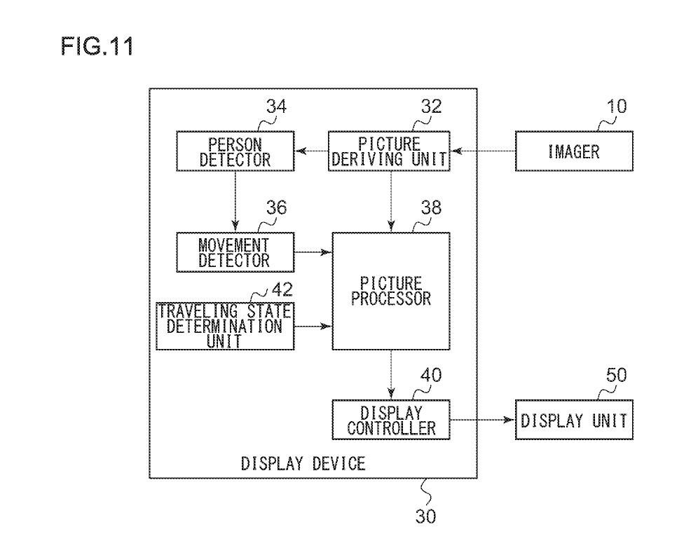

FIG. 11 shows a configuration of the display device 30 according to the fourth embodiment. The display device 30 is connected to the imager 10 and the display unit 50. The display device 30 comprises the picture deriving unit 32, person detector 34, movement detector 36, picture processor 38, display controller 40, and a traveling state determination unit 42.

The traveling state determination unit 42 is connected to a network, such as one based on the controller area network (CAN), and derives traveling information from an electronic controller (ECU) via the CAN network. The traveling information includes the selected gear and the vehicle speed, for example. Based on the traveling information, the traveling state determination unit 42 determines the traveling state of the vehicle equipped with the display device 30. More specifically, the traveling state determination unit 42 determines whether the vehicle is traveling at a low speed or at a high speed. The low-speed traveling means the case where a drive gear is selected and the vehicle is traveling at a speed lower than a threshold. The threshold may be set to 10 km/h, for example, so that the low-speed traveling corresponds to driving in turning right or left at an intersection, waiting for a traffic light, or during traffic congestion. Meanwhile, the high-speed traveling means the case where a drive gear is selected and the vehicle is traveling at a speed higher than or equal to the threshold. The traveling state determination unit 42 outputs the determination result to the picture processor 38.

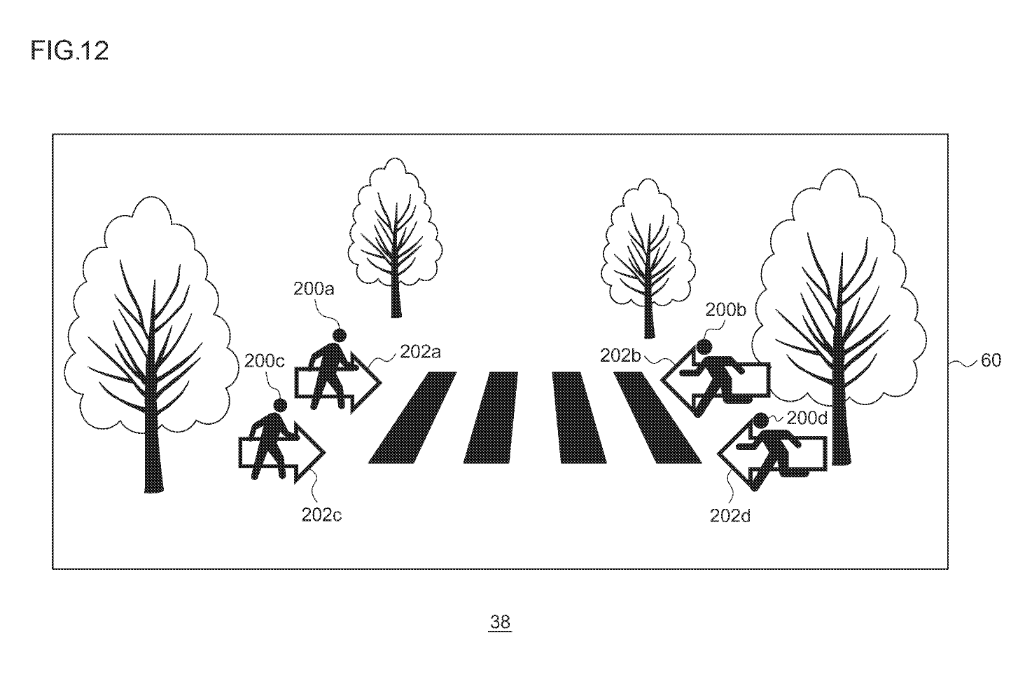

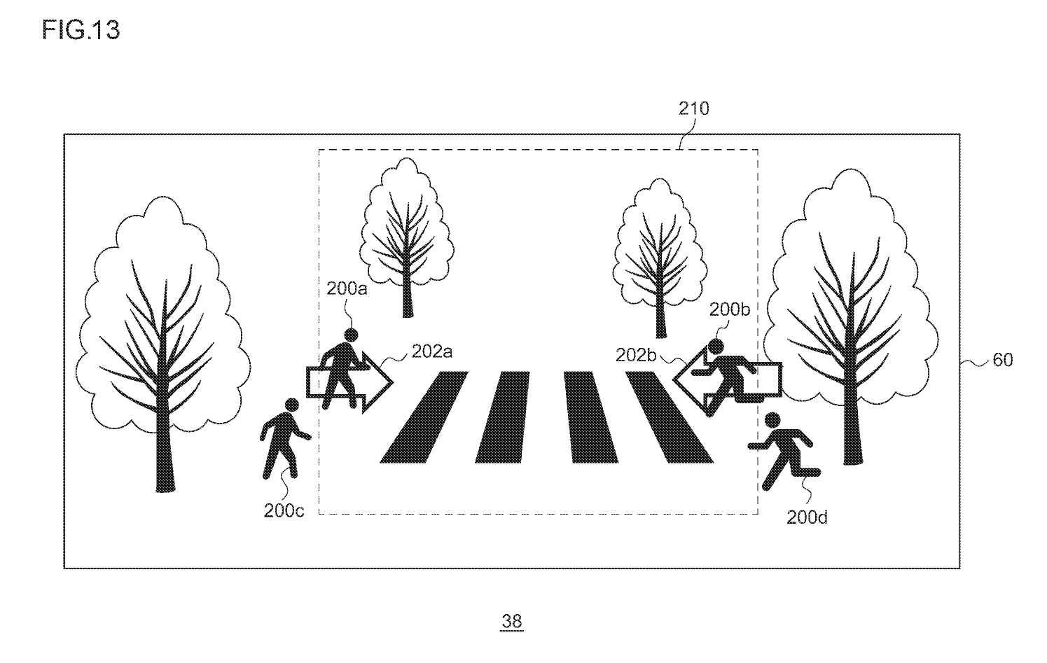

Accordingly, the picture processor 38 also receives the determination result from the traveling state determination unit 42. When the determination result is low-speed traveling, the picture processor 38 performs the same processing as described previously to generate a display picture 60. FIG. 12 shows a display picture 60 generated in the picture processor 38. In FIG. 12, the first person 200a through the fourth person 200d are detected, and the first arrow-shaped icon 202a through the fourth arrow-shaped icon 202d are respectively superimposed thereon. The first person 200a and the second person 200b are positioned closer to the road on which the subject vehicle is traveling than the third person 200c and the fourth person 200d are. The description will now return to FIG. 11.

When the determination result is high-speed traveling, on the other hand, the picture processor 38 limits the range (hereinafter, referred to as the “display range”) in which arrow-shaped icons 202 can be superimposed on persons 200, compared to the case of low-speed traveling. FIG. 13 shows another display picture 60 generated in the picture processor 38. FIG. 13 is shown similarly to FIG. 12, but a display range 210, which includes the road on which the subject vehicle is traveling, is provided. The picture processor 38 superimposes an arrow-shaped icon 202 only on a person 200 included in the display range 210 and does not superimpose an arrow-shaped icon 202 on a person 200 present outside the display range 210. Accordingly, the first arrow-shaped icon 202a and the second arrow-shaped icon 202b are superimposed respectively on the first person 200a and the second person 200b, but no arrow-shaped icon 202 is superimposed on the third person 200c and the fourth person 200d. This is because, when the vehicle speed increases, the necessity to detect a person 200 around the vehicle decreases, while the necessity to detect a person 200 in front of the vehicle increases. Namely, the picture processor 38 changes the range in which an arrow-shaped icon 202 indicating a moving direction is displayed, depending on the traveling state determined by the traveling state determination unit 42. The description will now return to FIG. 11.

The subsequent processing performed by the picture processor 38, display controller 40, and display unit 50 is the same as that described previously. Consequently, when the traveling state is high-speed traveling, the display unit 50 limits the range in which arrow-shaped icons 202 are superimposed on persons 200, compared to the case of low-speed traveling.

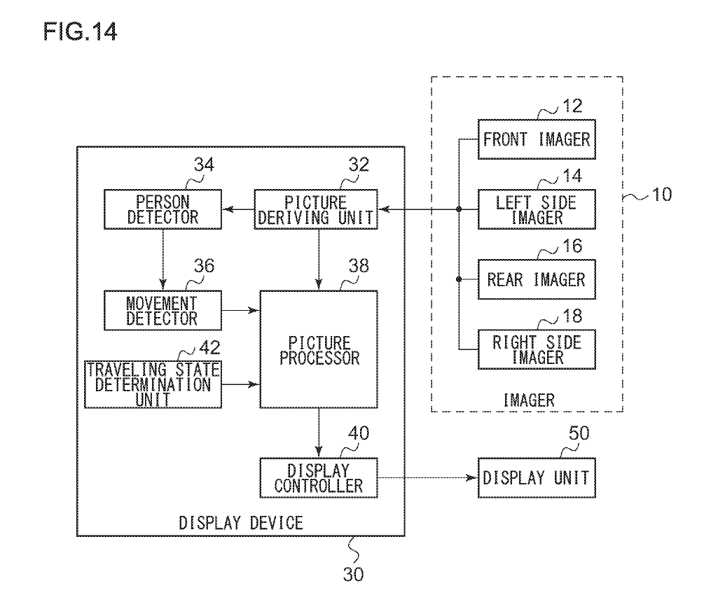

Such processing may be performed on a bird's-eye picture. FIG. 14 shows another configuration of the display device 30 according to the fourth embodiment. The display device 30 has the same configuration as the display device 30 shown in FIG. 11, but the imager 10 is configured as shown in FIG. 4. Since the processing performed in this case corresponds to the combination of the processing performed in the display device 30 shown in FIG. 4 and the processing performed in the display device 30 shown in FIG. 11, the explanation thereof is omitted here. For example, when the traveling speed of the vehicle is low, the display device 30 only displays the arrow-shaped icons 222 starting from the person icons 220 included in the bird's-eye picture 78, as shown in FIG. 5. When the traveling speed of the vehicle is a predetermined speed or higher, on the other hand, the display device 30 also displays the arrow-shaped icons 222 starting from the person icons 220 not included in the bird's-eye picture 78, as shown in FIG. 10. The case where the traveling speed of the vehicle is low may be that where the traveling speed is lower than 10 km/h, and the case where the traveling speed of the vehicle is a predetermined speed or higher may be that where the traveling speed is higher than or equal to 10 km/h, for example.

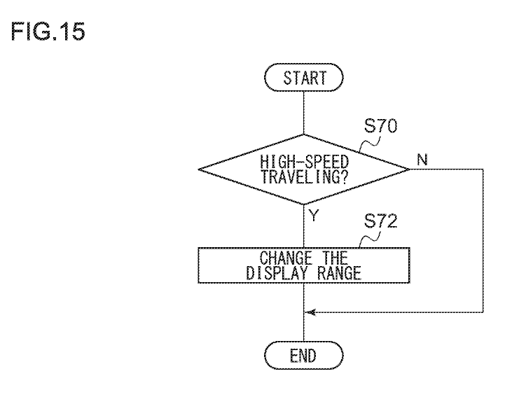

There will now be described an operation performed by the display device 30 having the configuration set forth above. FIG. 15 is a flowchart that shows a display procedure performed by the display device 30. If the traveling state is high-speed traveling (Y at S70), the picture processor 38 will change the display range 210 (S72). If the traveling state is not high-speed traveling (N at S70), the picture processor 38 will skip the process of Step 72.

According to the present embodiment, when the traveling state is low-speed traveling, the range in which a person is displayed with an arrow-shaped icon is made larger, so that the driver can find a person present around the vehicle. Since the driver can find a person present around the vehicle, it contributes to safe driving. Also, when the traveling state is high-speed traveling, the range in which a person is displayed with an arrow-shaped icon is limited, so that the driver can find the moving direction of a person present in the range to watch. Since the driver can find the moving direction of a person present in the range to watch, the alerting effect for the driver can be maintained even in high-speed traveling.

### Fifth Embodiment

Next, the fifth embodiment will be described. As with the aforementioned embodiments, the fifth embodiment relates to a display device that displays a picture captured by an imager mounted on a front part of a vehicle and that superimposes and displays, on the picture, an icon indicating the moving direction of a person. In the first embodiment, an arrow-shaped icon is displayed as an icon indicating the moving direction of a person. However, there are persons who change their moving directions and do not move in a fixed direction. In this case, displaying arrow-shaped icons will be difficult. Accordingly, the fifth embodiment relates to an icon displayed in such a case. The display device 30 according to the fifth embodiment is of a similar type to the display device 30 shown in FIG. 1. Accordingly, description will be given mainly of the differences from the aforementioned embodiments.

The picture deriving unit 32, person detector 34, and movement detector 36 perform the same processing as described in the first embodiment. The movement detector 36 monitors the moving direction of a person 200 and checks if the moving direction changes during a predetermined period. The predetermined period may be defined as two or three seconds, for example. When the moving direction has changed, the movement detector 36 outputs, to the picture processor 38, information indicating that the moving direction is changing, instead of the information regarding the moving direction and the information regarding the moving speed.

The movement detector 36 also identifies the size in a longitudinal direction, i.e., the height, of a detected person 200 to check if the identified size of the person 200 is less than a predetermined size. The predetermined size may be defined as 100-120 cm, for example, and such processing in the movement detector 36 corresponds to checking if the person 200 is a child. Generally, a child often suddenly starts running or changes the moving direction, so that the information regarding the moving direction or the information regarding the moving speed may be sometimes meaningless. Accordingly, when the size of the person 200 is less than the predetermined size, the movement detector 36 outputs, to the picture processor 38, information indicating that the person 200 is a child, instead of the information regarding the moving direction and the information regarding the moving speed. Such processing is performed for each person 200.

In the processing for identifying the height, the size of an identified person 200 may be judged to be less than the predetermined size only when the size does not change for a predetermined period of time. More specifically, the judgement may be performed based on frames of pictures captured for a time required to detect the speed of the identified person 200, such as for 3 seconds. Such judgement prevents the case where the size of a person 200, which is greater than or equal to the predetermined size, is recognized to be less than the predetermined size because of a temporary movement, such as bending down, of the person 200. Also, a person 200 is detected with reference to a dictionary used to recognize a person based on a captured picture, and the size in a longitudinal direction of the person 200 is identified with reference to the dictionary based on the top of a portion recognized as a head. This prevents the case where the size of a person, which is less than the predetermined size, is not recognized to be less than the predetermined size because of a movement, such as raising a hand, of the person.

The picture processor 38 receives the information indicating that the moving direction of a certain person 200 is changing, or the information indicating that a certain person 200 is a child. The picture processor 38 then performs the same processing as described in the first embodiment and identifies the aforementioned certain person 200 in each of multiple pictures included in the picture information. Also, the picture processor 38 generates a display picture 60 by superimposing, on the identified person 200, an icon (hereinafter, referred to as a “range icon”) indicating a movable range of the person 200, instead of an arrow-shaped icon 202. The range icon is an icon in which a circle is drawn around a person 200 on a horizontal plane, indicating that the person 200 may move within the range shown by the range icon. Accordingly, it can be said that the range icon is also an icon indicating a moving direction.

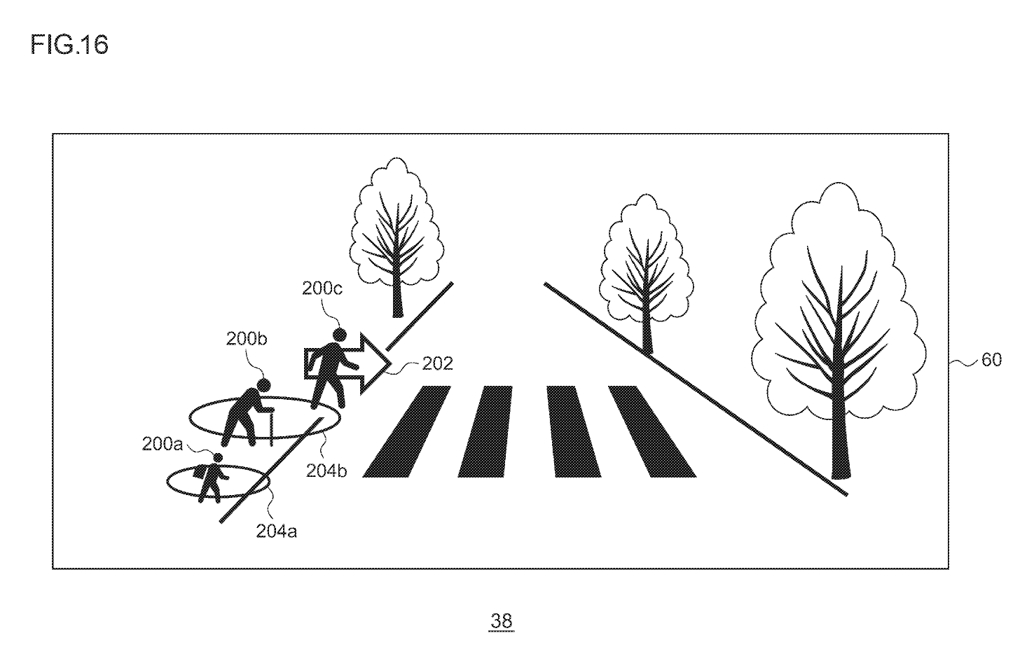

FIG. 16 shows a display picture 60 generated in the picture processor 38 according to the fifth embodiment. On the display picture 60, the first person 200a, the second person 200b, and the third person 200c are detected. The first person 200a is detected as a child by the movement detector 36. Also, the fact that the moving direction of the second person 200b is changing is detected by the movement detector 36. Accordingly, a first range icon 204a is superimposed on the first person 200a, and a second range icon 204b is superimposed on the second person 200b. Meanwhile, on the third person 200c, an arrow-shaped icon 202 is superimposed through the same processing as described in the first embodiment. The description will now return to FIG. 1. The subsequent processing performed by the picture processor 38, display controller 40, and display unit 50 is the same as that described previously. Consequently, when the moving direction of a person 200 is changing or when the size of a person 200 is less than the predetermined size, the display unit 50 displays a range icon 204 indicating a movable range around the person 200.

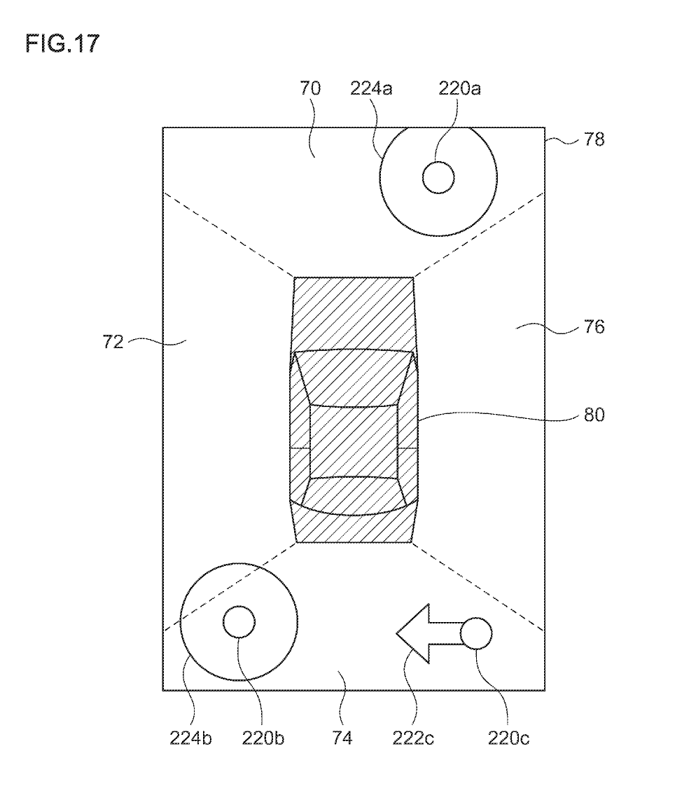

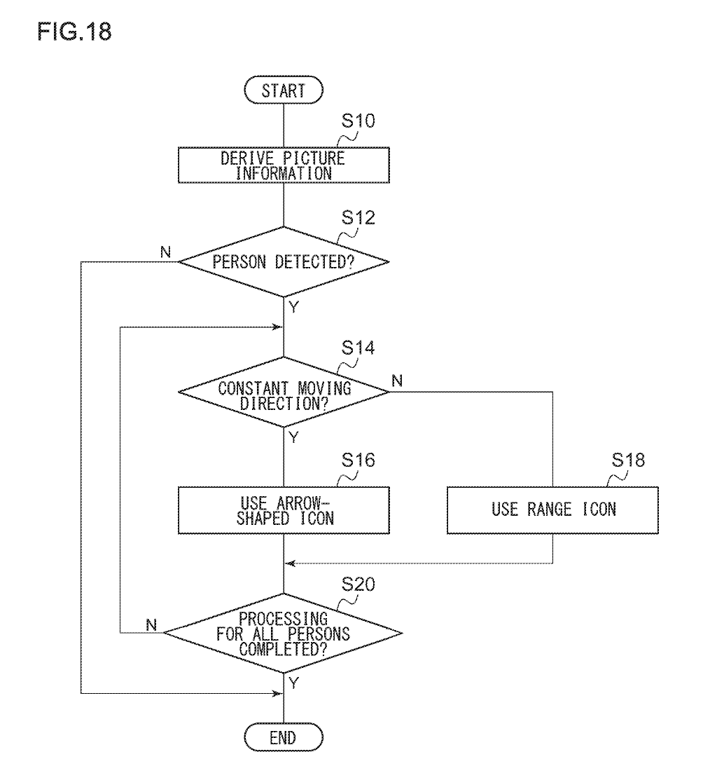

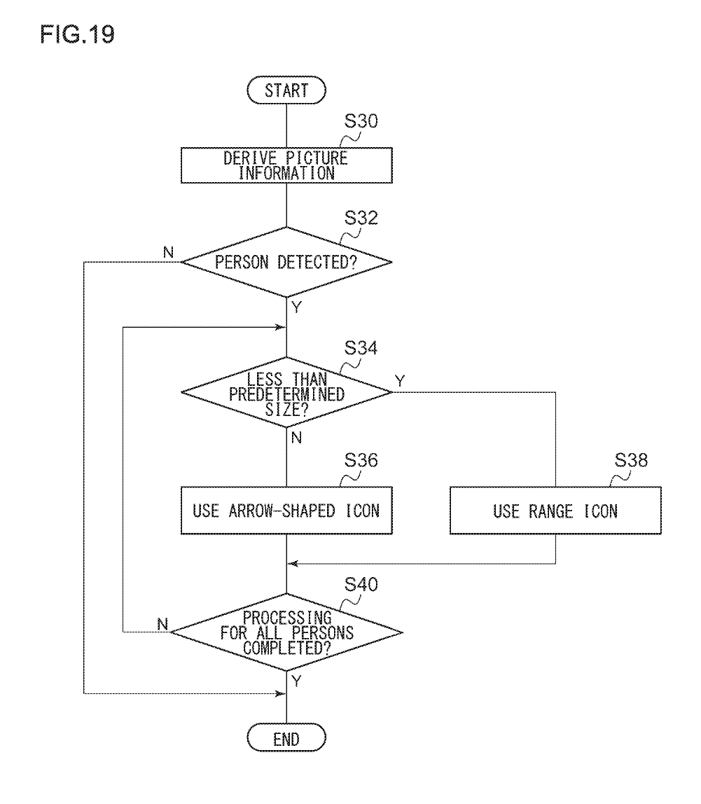

Such processing may be performed on a bird's-eye picture. The display device 30 in the case is of a similar type to the display device 30 shown in FIG. 4. Since the processing performed in the display device 30 is the same as that described previously, the explanation thereof is omitted here. FIG. 17 shows a bird's-eye picture 78 generated in the picture processor 38 according to the fifth embodiment. The person corresponding to the first person icon 220a is detected as a child by the movement detector 36. Also, the fact that the moving direction of the person corresponding to the second person icon 220b is changing is detected by the movement detector 36. Accordingly, a first range icon 224a is superimposed on the first person icon 220a, and a second range icon 224b is superimposed on the second person icon 220b. Meanwhile, on the third person icon 220c, the third arrow-shaped icon 222c is superimposed through the same processing as described in the first embodiment.

There will now be described an operation performed by the display device 30 having the configuration set forth above. FIG. 18 is a flowchart that shows a display procedure performed by the display device 30 according to the fifth embodiment. The picture deriving unit 32 derives picture information (S10). If the person detector 34 does not detect a person 200 (N at S12), the process will terminate. If the person detector 34 detects a person 200 (Y at S12) and if a moving direction detected by the movement detector 36 is constant (Y at S14), the picture processor 38 will use an arrow-shaped icon 202 (S16). If the moving direction detected by the movement detector 36 is not constant (N at S14), the picture processor 38 will use a range icon 204 (S18). If the processing for all the persons 200 is not completed (N at S20), the process will return to Step 14. If the processing for all the persons 200 is completed (Y at S20), the process will terminate.

FIG. 19 is a flowchart that shows another display procedure performed by the display device 30 according to the fifth embodiment. The picture deriving unit 32 derives picture information (S30). If the person detector 34 does not detect a person 200 (N at S32), the process will terminate. If the person detector 34 detects a person 200 (Y at S32) and if the size of the person 200 is not judged to be less than a predetermined size by the movement detector 36 (N at S34), the picture processor 38 will use an arrow-shaped icon 202 (S36). If the size of the person 200 is judged to be less than the predetermined size by the movement detector 36 (Y at S34), the picture processor 38 will use a range icon 204 (S38). If the processing for all the persons 200 is not completed (N at S40), the process will return to Step 34. If the processing for all the persons 200 is completed (Y at S40), the process will terminate.

According to the present embodiment, when a moving direction is changing, a range icon is displayed around the person, so that the driver can find the movable range of the person. Since a range icon is displayed around a person whose moving direction is changing, the moving direction need not be identified. Also, when the size of a detected person is less than a predetermined size, a range icon is displayed around the person, so that the driver can find the movable range of the person. Since a range icon is displayed around a detected person when the size of the person is less than a predetermined size, the moving direction need not be identified.

The present invention has been described with reference to embodiments. The embodiments are intended to be illustrative only, and it will be obvious to those skilled in the art that various modifications to a combination of constituting elements or processes could be developed and that such modifications also fall within the scope of the present invention.

In the first through fifth embodiments, the display unit 50 is a monitor mounted on the driver's side of a vehicle. However, the application is not limited thereto, and the display unit 50 may be a head-up display (HUD), for example. In this case, the picture processor 38 generates a virtual picture to be displayed on the HUD, and the arrow-shaped icons 202 and the range icons 204 are arranged on the virtual picture. This modification allows greater flexibility in display.

In the first through fifth embodiments, the imager 10 is mounted on a front part of a vehicle. However, the operation is not limited thereto, and the imager 10 may be mounted on a side part or a rear part of a vehicle, for example. According to this modification, the driver can find the moving direction of a person when parking the vehicle or driving on a narrow road.

Optional combinations of the first through fifth embodiments may also be practiced. According to this modification, effects of combinations can be obtained.

What is claimed is:

1. A display device, comprising:
a picture deriving unit that derives picture information of a captured picture of vicinity of a vehicle;
a person detector that detects a person in picture information derived by the picture deriving unit;
a movement detector that detects the moving direction of a person detected by the person detector;
a display controller that displays, on a display unit, picture information derived by the picture deriving unit and an icon indicating the moving direction of a person detected by the movement detector; and
a traveling state determination unit that determines the traveling state of a vehicle equipped with the display device, wherein
the display controller changes a range in which an icon indicating the moving direction is displayed, depending on the traveling state determined by the traveling state determination unit.

2. The display device of claim 1, further comprising a generator that generates a bird's-eye picture by converting the viewpoint for picture information derived by the picture deriving unit, wherein
the display controller displays, on the display unit, a bird's-eye picture generated by the generator and an icon indicating the moving direction of a person detected by the movement detector.

3. The display device of claim 1, wherein the display controller clips and displays, on the display unit, part of picture information derived by the picture deriving unit and also displays on the display unit an icon indicating the moving direction of a person present outside the range displayed on the display unit.

4. The display device of claim 3, wherein the display controller displays on the display unit an icon indicating the moving direction of a person who is present outside the range displayed on the display unit and is moving toward the range.

5. The display device of claim 1, wherein the display controller displays an icon indicating the moving direction of a person moving toward a position along the traveling direction of the vehicle.

6. The display device of claim 1, wherein:
the movement detector also detects the moving speed of a person detected by the person detector; and
the display controller displays, as an icon indicating the moving direction, an arrow-shaped icon having an appearance corresponding to a moving speed detected by the movement detector.

7. The display device of claim 1, wherein the display controller displays an icon indicating the moving direction, the icon starting from the person detected in the picture information and extending in the moving direction of the person.

8. The display device of claim 1, wherein, when a moving direction detected by the movement detector is changing, the display controller displays, around the person detected by the person detector, an icon indicating a movable range of the person, as an icon indicating the moving direction.

9. The display device of claim 1, wherein, when the size of a person detected by the person detector is less than a predetermined size, the display controller displays, around the person detected by the person detector, an icon indicating a movable range of the person, as an icon indicating the moving direction.

10. A display method, comprising:
picture deriving of deriving picture information of a captured picture of vicinity of a vehicle;
person detection of detecting a person in picture information derived in the picture deriving;
movement detection of detecting the moving direction of a person detected in the person detection;
displaying, on a display unit, picture information derived in the picture deriving and an icon indicating the moving direction of a person detected in the movement detection; and
traveling state determination of determining the traveling state of a vehicle, wherein
in the displaying, a range in which an icon indicating the moving direction is displayed is changed depending on the traveling state determined in the traveling state determination.

11. A non-transitory computer-readable memory medium storing a computer program comprising:
picture deriving of deriving picture information of a captured picture of vicinity of a vehicle;
person detection of detecting a person in picture information derived in the picture deriving;
movement detection of detecting the moving direction of a person detected in the person detection;
displaying, on a display unit, picture information derived in the picture deriving and an icon indicating the moving direction of a person detected in the movement detection; and
traveling state determination of determining the traveling state of a vehicle, wherein
in the displaying, a range in which an icon indicating the moving direction is displayed is changed depending on the traveling state determined in the traveling state determination.
